(19) United States
(12) Patent Application Publication
(10) Pub. No.: US 2026/0335932 A1
(43) Pub. Date: Oct. 29, 2026

(54) Non-Fluorinated Silicone Resin-Based Coating Comprising A Temperature Indicator

(71) Applicant: SEB S.A., Ecully (FR)

(72) Inventors: Angélique Beaulieu, Ecully Cedex (FR); Ingrid Jouanneau, Ecully Cedex (FR); Perrine Tanguy, Ecully Cedex (FR); Anne Teissier, Ecully Cedex (FR)

(73) Assignee: SEB S.A., Ecully (FR)

(21) Appl. No.: 19/099,142

(22) PCT Filed: Jul. 28, 2023
(86) PCT No.: PCT/FR2023/051208

§ 371 Date: Jan. 28, 2025

(30) Foreign Application Priority Data
Jul. 29, 2022 (FR) FR2207894

(51) Int. Cl. B05D 5/08; A47J 36/02; B05D 7/14

(52) U.S. Cl. CPC B05D 5/08; A47J 36/025; B05D 7/14; B05D 2202/15; B05D 2202/25; B05D 2350/63; B05D 2425/01; B05D 2430/00; B05D 2601/02

(57) ABSTRACT

A coated cooking element for a kitchen utensil or electrical cooking appliance includes a metal substrate coated, on at least one face, with at least the following layers in said order starting from the metal substrate: a base layer having one or more silicone resins and optionally—one or more thermoplastic polymers, and/or—one or more coloring agents selected from the group having thermochromic pigments, thermostable pigments, flakes, and mixtures thereof, and/or—one or more fillers, and/or—one or more additives, one or more intermediate layers consisting of one or more coloring agents selected from the group consisting of thermochromic pigments, thermostable pigments, flakes, and mixtures thereof, and optionally—one or more silicone resins, and/or—one or more thermoplastic polymers, and or—one or more fillers, and/or—one or more additives, a finishing layer consisting of one or more silicone resins and optionally—one or more thermoplastic polymers, and/or—one or more fillers, and/or—one or more additives, and/or—flakes.

The field of the invention is that of culinary items coated on one of their faces with a coating and more precisely, the silicone resin-based coatings of these articles.

In the field of culinary items, fluoropolymer-based coatings and, in particular, polytetrafluoroethylene (PTFE) are known to the general public for their non-stick and temperature resistance properties.

However, these coatings have a low mechanical strength.

Application WO 2020/144051 relates to a fluoropolymer-based coating, for which the mechanical resistance to abrasion is improved by incorporation of organic (SiC) and mineral (Al₂O₃) fillers in the primary and finishing layers of the coating.

The improvement in performance achieved with regard to mechanical strength is satisfactory, but still not optimal.

The fluoropolymer-based coatings are primarily intended for pots and pans, but other applications are possible in the field of the moulding (moulds, cake dishes, waffle makers, etc.) or small domestic equipment (rice cookers, fryer vessels, electric crepe makers) due to their stamping properties.

An alternative to PTFE coatings consists of using so-called “ceramic” coatings, developed by the sol-gel method and the use of tetraethyl orthosilicate (EP 2 806 776 B1). These coatings have the particular properties of being hard and resistant to mechanical wear, but also exhibiting brittle behaviour and lower non-stick properties compared to fluoropolymer-based coatings.

In addition, these coatings are not very suitable for moulding and for small domestic equipment due to their lack of stamping properties.

In the field of moulding (by the general public or industrial moulding), fluoropolymer-based coatings are not as widespread, because the temperature resistance constraints are lower (maximum 220 °C) and allow the use of other types of coatings, such as silicone coatings.

Pure silicone resins are described as anti-adhesives and resistant to temperatures greater than 220-230 °C. By contrast, they are considered to adhere poorly to the substrate.

On the other hand, silicone-polyester resins are very widely used in moulding because they are non-stick while adhering to the substrate and being compatible with stamping processes. However, they degrade at temperatures greater than 230 °C. More specifically, culinary items are used in the temperature range between 5° and 250 °C and it is not surprising to reach temperatures of 300 °C or even 350 °C in the case of articles with induction bottoms. Their use is therefore not compatible with the temperatures of use in the field of culinary items.

However, control of the cooking temperature is an essential parameter because it determines successful cooking and ensures the preservation of the physicochemical properties of the non-stick coatings. With this in mind, cooking start temperature indicators have been developed for consumers. The aim is to indicate, by a change of colour, the temperature at which the consumers can start their cooking and thus avoid any possible overheating.

This technology generally relies on the use of thermochromic pigments, the colours of which change between ambient temperature and 250 °C, depending on the nature of the material.

In addition to thermochromic pigments, other visual differentiating elements can be added in the coatings (EP 2 675 328 A1, EP 2 412 846 B1).

Patent EP 2 319 631 describes the development of a two-layer silicone resin-based coating coupled with a high-temperature thermoplastic material between 0.5 and 20% (base layer), making it possible to obtain a coating that is mechanically strong, adherent to the substrate and non-stick. The nature of the thermoplastic varies between the base layer (PEEK) and the finishing layer (PPS) and this is mainly located in the base layer in order to ensure adherence to the substrate. This patent does not describe a temperature indicator.

Application US 2022/0073785 proposes two-layer silicone/thermoplastic coating architecture which is much more concentrated in thermoplastic material and also does not describe the incorporation of a colour indicator based on thermochromic pigments.

### SUMMARY OF THE INVENTION

The first object of the invention relates to a coated cooking element (1) for a culinary item or electrical cooking appliance, comprising a metal substrate (2) coated on at least one face (2a) by at least the following layers, in this order starting from the metal substrate (2):
(3a) a base layer consisting of one or more silicone resins and optionally
   one or more thermoplastic polymers, and/or
   one or more colouring agents selected from the group consisting of thermochromic pigments, thermostable pigments, flakes, and the mixtures thereof, and/or
   one or more fillers, and/or
   one or more additives
(3b) one or more intermediate layers consisting of one or more colouring agents selected from the group consisting of thermochromic pigments, thermostable pigments, flakes, and the mixtures thereof, and optionally
   one or more silicone resins, and/or
   one or more thermoplastic polymers and/or,
   one or more fillers, and/or
   one or more additives
(3c) a finishing layer consisting of one or more silicone resins and optionally
   one or more thermoplastic polymers, and/or
   one or more fillers, and/or
   one or more additives, and/or
   flakes.

Another object of the invention relates to a method for manufacturing a coated cooking element (1) according to the invention comprising the following successive steps:
i. supplying a metal substrate (2) having a face (2a),
ii. optionally, prior treatment of the face (2a) of said metal substrate (2) intended to be coated,
iii. applying the base layer (3a),
iv. drying the base layer (3a),
v. applying one or more intermediate layers (3b),
vi. optionally, drying the one or more intermediate layers (3b),
vii. applying the finishing layer (3c).

Another object of the invention relates to a kitchen utensil (100) comprising a coated cooking element (1) according to the invention.

Another object of the invention relates to an electric cooking appliance (200) comprising a coated cooking element (1) according to the invention and a heating source (210) designed to heat said coated cooking element (1).

### DEFINITIONS

The term “layer” should be understood, in the context of the present invention, as a continuous or discontinuous layer. A continuous layer (also called a monolithic layer) is a single whole forming a total flat surface completely covering the surface on which it is applied. A non-continuous layer (or non-monolithic layer) can comprise a plurality of portions, thus not being a single whole.

The term “base”, “primer layer”, “bonding layer” or “bonding primer” shall mean all the layers, from the first layer applied directly on the support (it is preferable that this layer adheres well to the support and provides the coating with all its mechanical properties: hardness, scratch resistance) to the last layer before the first decoration layer.

The term “finishing layer” or “finish” shall mean a continuous transparent surface layer, this layer allowing perfect visibility of the decoration layer while protecting it from mechanical attacks and giving the coating non-stick properties. Preferably, the last finishing layer is intended to be in contact with the food.

The term “decoration” or “decoration layer” shall mean one or more continuous or discontinuous layers comprising a pigmentary composition. The decoration can be in the form of one or more patterns, with one or more colours. A decoration is clearly visible to the user with the naked eye and at a conventional distance of use of the household item.

The term “overlapping layers” shall mean partially or completely superposed layers. These layers can be in the form of partially overlapping patterns, for example concentric discs.

The term “adjacent layers” shall mean non-superimposed layers. These layers can be in the form of non-superimposed, identical or different patterns, preferably uniformly distributed.

The term “reference temperature pigmentary composition” shall mean a composition comprising a pigment which, at a given temperature, can indicate to the user that the optimum temperature of use has been reached. This indication is made by comparing the colours of the thermochromic pigmentary composition and of the reference temperature pigmentary composition. Either the optimum temperature of use is reached when the colours are identical, or the optimum temperature of use is reached when the colours are visually very different.

The “reference temperature pigmentary composition” can comprise a pigment which has:
the same colour as the thermochromic pigmentary composition, at the optimum temperature of use,
either because at ambient temperature this pigment has the same colour as the thermochromic pigmentary composition at the optimum temperature of use, and does not change colour with temperature,
or because at ambient temperature this pigment has a different colour from that of the thermochromic pigmentary composition which changes to the same colour as the thermochromic pigmentary composition at the optimum temperature of use,
a very different colour of that of the thermochromic pigmentary composition at the optimum temperature of use, whether or not this pigment changes colour or not with the change in temperature.

The optimum temperature of use can be reached when the colour of the reference temperature pigmentary composition corresponds to a colour indicated in the user guide of the household item comprising the coating of the invention or to a colour indicated on a colour scale supplied to the user with said item.

The reference temperature pigmentary composition is thermochromic or thermostable.

The reference temperature pigmentary composition can be, for example, a reference cooking temperature pigmentary composition or be for indicating a risk of overheating.

The present invention has at least the following advantages:
the coating according to the invention has a thermochromic functionality with a marked visibility, a colour change contrasted over a targeted range of temperatures and centred, for example, around food cooking temperatures for a kitchen appliance;
the coating according to the invention can provide a good temperature control when cooking food, which is necessary for health and taste reasons, but also for safety and to limit occasional overheating which weakens the coating;
the thermochromic pigmentary composition has reversible thermochromic properties, i.e. after a colour change under the action of heat the compound returns to its initial state and to its initial colour, when the temperature is reduced; this colour change cycle (reversibility) can be infinitely repeated;
the coating according to the invention has a significant thermal stability when the temperature rises; it is stable up to approximately 450 °C.

The expression “thermochromic semiconductor” shall mean that it must comprise, within the meaning of the present invention, a mineral or organic compound which has a reversible change of colour following an increase in temperature. The gradual and reversible thermochromic nature of these semiconductor compounds is linked to the reduction in the width of the band gap of the semiconductor due to the expansion of the material. More specifically, the periodicity of the lattice of anions and cations leads to the gathering of the energy levels into energy bands. The higher-energy filled energy band is called the valence band and the lower-energy empty energy band is called the conduction band. Between these two bands, there is a forbidden band called the band gap. The colour of a semiconductor material can come from the presence of a charge transfer which corresponds to the passage of an electron either from the valence band to a conduction band on a given atom, or commonly from the orbit of an anion to the orbit of a cation (inter-atomic photon absorption).

In the fields of application intended for the present invention, the optimum conditions are attained when the coating reaches a temperature suitable for the cooking of food, preferably between 10° and 250 °C.

In the context of the present invention, the term “pigment or thermochromic pigmentary composition” should be understood to mean a pigment or a pigmentary composition which changes colour as a function of temperature in a given temperature range, this change being reversible. This colour change is visible to the user with the naked eye and at a conventional distance of use.

The term “thermostable pigment” shall mean a pigment which does not exhibit a colour change when it is subjected to an increase in temperature in a given temperature range, or which exhibits a change in hue when it is subject to an increase in temperature in a given temperature range which is so small that it is not visible to the user with the naked eye and at a conventional distance of use.

Thermostable pigments preferably have a colour deviation ΔE* between 25 °C and 200 °C less than 10, ΔE* being defined by the CIE1976 formula in the CIELAB colour space:

ΔE*=\sqrt{(L₂*-L₁*)²+(a₂*-a₁*)²+(b₂*−b₁*)²}

L₁*, a₁* and b₁* characterising the L*a*b* values of said compound at ambient temperature, L₂*, a₂* and b₂* characterising the L*a*b* values of said compound at 200 °C.

The expression “the colours are identical” shall mean that they are indistinguishable by the user with the naked eye and at a conventional distance of use.

The expression “culinary item” shall be understood, in the context of the present invention, as an item intended for cooking. For this purpose, it is intended to receive a heat treatment.

The expression “item intended to receive a heat treatment” should be understood, in the context of the present invention, as an item which will be heated by an external heating system, such as frying pans, saucepans, sauté pans, woks and barbecue grills, and which is capable of transferring heat provided by this external heating system to a material or food in contact with said item.

The expression “electrical cooking appliance” should be understood, in the context of the present invention, as a heating object having its own heating system such as an electric crêpe maker, electric raclette appliance, electric fondue appliance, electric grill, electric plancha grill, electric cooker, bread-making machine or electric pressure-cooking appliance.

The term “coating” shall mean all of the layers covering the metal substrate and adhering to this substrate.

The term “silicone resin-based coating” shall mean a coating which comprises one or more silicone resins in one or more of its layers. The coating obtained according to the invention is advantageously solid. The term “solid” refers to the property of a cohesive material that is insoluble in water, in normal solvents, in the food components such as aqueous or fatty mixtures, even if the material may have a high hardness or high flexibility like an elastomer.

In the present invention, the % by weight are expressed by dry weight, i.e. without solvent.

### FIGURES

FIG. 1: diagram of a cooking element according to the invention, for which layer (3b) is continuous and covers the entirety of the layer (3a)

FIG. 2: diagram of a cooking element according to the invention, for which the layer (3b) does not cover the entirety of the layer (3a) and forms a decoration

FIG. 3: diagram of a cooking element according to the invention, for which the layer (3b) consists of two decorations (i) and (j)

FIG. 4: pattern distribution diagram. 4A=non-overlapping adjacent patterns. 4B=partially overlapping patterns. 4C=overlapping patterns.

FIG. 5: diagram of a culinary item according to the invention

FIG. 6: diagram of an electrical cooking appliance according to the invention

### DETAILED DESCRIPTION OF THE INVENTION

The invention relates to a coated cooking element (1) for a culinary item or electrical cooking appliance, comprising a metal substrate (2) coated on at least one face (2a) by at least the following layers, in this order starting from the metal substrate (2):
(3a) a base layer consisting of one or more silicone resins and optionally
   one or more thermoplastic polymers, and/or
   one or more colouring agents selected from the group consisting of thermochromic pigments, thermostable pigments, flakes, and the mixtures thereof, and/or
   one or more fillers, and/or
   one or more additives
(3b) one or more, preferably two, intermediate layers consisting of one or more colouring agents selected from the group consisting of thermochromic pigments, thermostable pigments, flakes, and the mixtures thereof, and optionally
   one or more silicone resins, and/or
   one or more thermoplastic polymers and/or,
   one or more fillers, and/or
   one or more additives
(3c) a finishing layer consisting of one or more silicone resins and optionally
   one or more thermoplastic polymers, and/or
   one or more fillers, and/or
   one or more additives, and/or
   flakes.

Advantageously, the layers (3a), (3b) and (3c) form a coating (3) which coats the metal substrate (2). This coating (3) has non-stick properties and forms a non-stick coating.

Advantageously, the layer (3a) is in contact via one of its faces with the metal substrate (2) via its face (2a).

The at least one coated face (2a) of the metal substrate is therefore a cooking face. In other words, the coating of the cooking element (1) according to the invention is intended to be in contact with the food.

Advantageously, the finishing layer (3c) is in contact via one of its faces with food and thus forms a cooking face (5).

The coating (3) of the cooking element (1) according to the invention does not comprise a fluorinated polymer, also called a fluoropolymer. In other words, said coating is devoid of fluorinated polymers.

Advantageously, the thickness of the layer (3a) is between 10 μm and 100 μm, preferably between 20 μm and 85 μm, particularly preferably between 30 μm and 70 μm.

Advantageously, the thickness of the layer (3b) is between 1 μm and 100 μm, preferably between 2 μm and 30 μm, particularly preferably between 3 μm and 10 μm.

Advantageously, the thickness of the layer (3c) is between 0.05 μm and 100 μm, preferably between 0.08 μm and 20 μm, particularly preferably between 0.1 μm and 10 μm. In a particular embodiment of the invention, the thickness of the layer (3c) is 100 nm+/−5 nm.

According to an embodiment, the thickness of the layer (3c) is between 0.1 μm and 2 microns, preferably between 0.2 μm and 1.5 μm.

According to another embodiment, the thickness of the layer (3c) is between 10 μm and 100 μm, preferably between 20 μm and 85 μm, particularly preferably between 30 μm and 70 μm.

### Metal Substrate

Advantageously, said metal substrate (2) is a substrate made of aluminium, stainless steel, cast iron or aluminium, iron, titanium or copper.

Within the meaning of the present invention, aluminium shall be understood to be a metal composed of 100% aluminium or an aluminium alloy.

Advantageously, the metal substrate (2) is a substrate made of aluminium, stainless steel or a multilayer metal substrate. The metal substrate (2) can be a two-layer or three-layer substrate, these multiple layers being able to be obtained, for example, by co-lamination, by hot diffusion under load (solid state bonding) or by hot or cold impact bonding.

Preferably, the metal substrate (2) comprises alternating layers of metal and/or metallic alloy.

According to an embodiment, the metal substrate (2) is a substrate made of an aluminium or stainless-steel alloy, or a multilayer metal substrate for which the face (2a) is an aluminium or stainless-steel alloy.

Preferably, the metal substrate (2) is an aluminium substrate.

Advantageously, the thickness of the metal substrate (2) is between 0.5 mm and 10 mm.

Advantageously, the face (2a) of the metal substrate (2) has undergone a prior surface treatment for improving the adhesion of the coating to said substrate.

According to an embodiment, the surface of the face (2a) of the metal substrate (2) has undergone a surface treatment, said surface treatment being a chemical etching, brushing, hydratation, sandblasting, shot peening, physicochemical plasma, corona or laser treatment, chemical activation or a combination of these different techniques.

Advantageously, the face (2a) of the substrate on which the coating (3) according to the invention will be applied can be treated so as to increase its specific surface area; for an aluminium substrate, this treatment can be made by anodisation (creation of a tubular alumina structure), by chemical etching, sandblasting, brushing, shot peening or by addition of material using a technology such as thermal spraying (flame, plasma or arc spraying). Other metal substrates can also be polished, sandblasted, brushed, microbead blasted or receive an addition of material using a technology such as thermal spraying (flame, plasma or arc spraying).

Metals usable as substrates in the present invention advantageously include substrates made of aluminium that may or may not be anodised, optionally polished, brushed, sandblasted, shot peened or microbead blasted, substrates made of aluminium alloy which may or may not be anodised, optionally polished, brushed, sandblasted or microbead blasted, substrates made of steel which is optionally polished, brushed, sandblasted, shot peened or microbead blasted, substrates made of stainless steel which is optionally polished, brushed, sandblasted or microbead blasted, substrates made of cast steel, aluminium or iron, and substrates made of copper that is optionally hammered or polished.

Advantageously, the substrate can be selected from substrates comprising ferritic stainless steel/aluminium/austenitic stainless steel layers, substrates comprising stainless steel/aluminium/copper/aluminium/austenitic stainless steel layers, cast aluminium, aluminium or aluminium alloy calottes lined with an external base of stainless steel, metallic co-laminated substrates, for example two-layer co-laminated substrates comprising a stainless steel layer (for example intended to constitute the internal face of the item) and a layer of aluminium or aluminium alloy, anodised or not (for example intended to constitute the external face of the item).

Advantageously, the arithmetic mean roughness Ra of the surface of the face (2a) of the metal substrate (2) is greater than or equal to 1 μm.

The arithmetic mean roughness Ra is measured by means of a roughness meter according to standard ISO 4287. Ra represents the arithmetic mean of the deviations from the mean. The surface topography can be studied, in particular, using a profile meter with probe equipped with a fine stylus having a diamond tip, or with an Altisurf®-type optical metrology instrument in which a confocal chromatic sensor enables a contact free measurement. The study of this surface topography data makes it possible to define the arithmetic mean roughness Ra.

### Silicone Resins

In the text of the description, the expression “silicone resin” is used interchangeably to refer to silicone before or after its crosslinking. In the text of the description, the expression “silicone” designates an organopolysiloxane material. Crosslinking is the step which makes it possible to transform silicone into an insoluble material, for example by polyaddition, polycondensation or dehydrogenation. The crosslinking is performed on precursors which are generally oils or silicone resins, which crosslink in order to obtain a three-dimensional network forming a material called a silicone resin in the description.

This crosslinking can be carried out by thermal activation or chemical activation using a catalyst, such as platinum for example.

The silicone resins can be obtained from precursors that are advantageously soluble in a solvent or in emulsion in water, such as crosslinkable oils or resins, in particular selected from: a silicone hydride, a silicone oil resin comprising at least one vinyl group (—CH═CH₂), a silicone resin or silicone-polyester (copolymer) comprising at least one alkoxy group, for example a methoxy or ethoxy group, and/or a silicone resin or silicone-polyester (copolymer) comprising at least one alkoxy group, in particular an ethoxy group, or a hydroxy group and the mixtures thereof. These precursors have the ability to crosslink in order to obtain a silicone resin which is characterised by its insolubility and its substantially solid form.

Advantageously, these precursors are polymers or oligomers, either in the form of silicone oils with a variable degree of branching, or in the form of silicone resins with variable degrees of pre-crosslinking or silicone resin copolymers such as silicone resin-polyester, silicone-alkyds, silicone-polyurethanes, silicone-epoxy, or in the form of a mixture of silicone oils, silicone resins and silicone resin copolymers. The silicon atoms can be substituted by alkyl (in particular methyl) or aryl (in particular phenyl) groups or the mixtures thereof. The oils or resins preferably comprise one or more (2, 3 or more) hydroxy or alkoxy (in particular methoxy, ethoxy, butoxy) functional groups as substituents for silicon atoms.

Advantageously, the one or more silicone resins, obtained after crosslinking of their precursors, i.e. crosslinked, are selected from the group consisting of methyl silicone and/or phenyl silicone and/or methyl-phenyl-silicone resins, methyl silicone-polyester resin (copolymers), phenyl silicone-polyester resin (copolymers), methyl-phenyl silicone-polyester resin (copolymers), silicone-alkyd resin (copolymers), modified silicone resin and the mixtures thereof.

Advantageously, the one or more silicone resins are selected from the group consisting of methyl silicone and/or phenyl silicone and/or methyl-phenyl-silicone resins, methyl silicone-polyester resin (copolymers), phenyl silicone-polyester resin (copolymers), methyl-phenyl silicone-polyester resin (copolymers), silicone-alkyd resin (copolymers), modified silicone resin and the mixtures thereof.

The silicone resin of the single layer (3) forms a network which can consist of a combination of 4 single organosiloxane units denoted M, D, T and Q depending on the degree of substitution by oxygen of the silicon atom, as described in the following table, where R is a organic substituent described below.

| | Degree of substitution | |
|---|---|---|
| Structure | by oxygen | Symbol |
| R₃Si—O— | 1 | M |
| 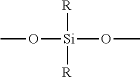 | 2 | D |
| 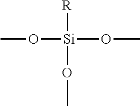 | 3 | T |
| 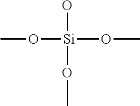 | 4 | Q |

The organopolysiloxane material or polymer is obtained by crosslinking from precursors which may be monomers or polymers, or in an intermediate manner which may be oligomers. The organopolysiloxane polymer can also be obtained from a mixture of these different sorts of precursors. When the network contains a higher number of T and Q units than D units, the crosslinking density is higher. The distribution between the M, D, T and Q units depends on the chemical structure of the precursors, in particular on this M, D, T, Q distribution within the precursors.

The polymer precursors are organopolysiloxanes. These macromolecules are formed of M, D, T, and/or Q units as described in the table, where R is independently an alkyl group, in particular methyl, or aryl, in particular phenyl, different types of R being able to be present on the same macromolecule.

The organopolysiloxanes can be either linear or slightly branched (mostly D groups), or branched or very branched (mostly T and Q groups). The linear or slightly branched organopolysiloxanes are generally liquids, more or less viscous at ambient temperature, and are called silicone oils. The branched or very branched (pre-crosslinked) organopolysiloxanes form a network on the individual macromolecule scale and are called silicone resins. At ambient temperature, the resins are substantially in solid form, or in liquid form provided that, in particular, they have a fairly low molecular mass, in the form of a solution in a solvent or in aqueous emulsion form. They can be copolymerised with organic polymers or oligomers not comprising silicon, selected in particular from polyesters, acrylics, alkyds, the polyurethane and epoxy resins.

When the crosslinking is a hydrolysis-polycondensation: it is carried out using the hydroxy or alkoxy reactive functions, in particular methoxy, ethoxy or butoxy, present on the organopolysiloxane.

When the crosslinking is a polyaddition (or hydrosilylation): it is carried out by reaction between the reactive vinyl functions (—CH═CH₂) present on one of the organopolysiloxanes and the reactive silyl-hydride functions (Si—H) present on the other organopolysiloxane mixed with the first.

All these reactive functions are present on each organopolysiloxane, being at least one in number, and can be present with 2, 3 or more in number, as much as the molecular structure allows. Silicone oils comprising at least one reactive function are called “reactive oils”. The reactive functions can be either at the end of a macromolecular chain (termination), or distributed over the chain.

Silicone resin-polyesters have, in particular, silicone/polyester mass ratios of, for example, 90/10, 80/20, 70/30, 60/40, 50/50, 40/50, 30/70, 20/80, 10/90, advantageously between 80/20 and 50/50.

Linear PDMS silicone oils, pure or pre-emulsified in water, are primarily characterised by their molecular mass, which is a directly increasing function of the viscosity of the pure oil. They are then characterised by the presence or otherwise of reactive functions, for example hydroxyls on the silicon atoms (silanol), their number and their location on the molecular chain. For example, reactive oils with viscosities between 50 and 20,000 mPa·s, and, in particular, between 300 and 5000 mPa·s, can be used, having at least one reactive function, preferably at least 2, which can be located at the end of the chain.

The polymer precursors reacting by polyaddition may include, for example, polymethylhydrosiloxane, vinylmethylsiloxane, vinyl-terminated, in particular linear, polydimethylsiloxane (PDMS), vinyl-terminated diphenylsiloxane-dimethylsiloxane copolymers, hydride-terminated polydimethylsiloxanes, hydride-terminated polyphenylmethylsiloxanes, cyclic vinylmethylsiloxane, vinyl-MQ resin, trimethylsilyl-terminated polymethylhydrosiloxane, trimethylsiloxane-terminated copolymer of methylhydrosiloxane and dimethylsiloxane, MQ resin hydride, and the like, as well as the combinations thereof.

The polymer precursors reacting by hydrolysis-polycondensation, whether they are silicone resins or silicone oils, can include, for example, poly(methylsilsesquioxanes), poly(propylsilsesquioxanes), poly(phenylsilsesquioxanes), polydimethylsiloxane (PDMS), trimethylsiyl-terminated polydimethylsiloxane (PDMS), hydroxyl-terminated polydimethylsiloxane (PDMS), silanol-terminated polydimethylsiloxane (PDMS), silanol-terminated polyphenylsiloxane (PDMS), the silanol-terminated copolymer of diphenylsiloxane-dimethylsiloxane, poly(2-acetoxyethylsilsesquioxanes), organo-modified alkoxy-silanes and their oligomers, and all similar macromolecules as well as the mixtures thereof.

The organopolysiloxane material or polymer can also be obtained by crosslinking of a mixture of one or more monomer precursors and one or more polymer precursors as described above, as well as one or more oligomer precursors which may be linear, branched or cyclic. These oligomer precursors have a lower molecular mass than the polymer precursors. Polymer and/or oligomer precursors comprising a number of reactive functions as described above, greater than 2, advantageously much greater than 2, can be added to the mixture as “co-binder” in order to promote a high crosslinking density of the organopolysiloxane polymer finally obtained.

The monomer, oligomer and/or polymer precursors, in particular silicone resins, copolymerised or not with an organic polymer, play the role of polymer binder with a view to obtaining solid organopolysiloxane polymer combined with the thermoplastics of each layer.

The silicone oil type organopolysiloxane precursors can be considered as additives if they are added in small quantity (in general between 0.1 and 5% dry) in the overall formulation of a layer, independently of other components for the formation of the solid organopolysiloxane polymer.

The crosslinking may require a catalyst:
in the case of crosslinking of organopolysiloxanes by hydrolysis-polycondensation, the formula can include a metal catalyst, such as metal complexes based on platinum, tin, zinc, zirconium and cerium, in particular the complexes platinum-cyclovinylmethyl-siloxane, tin ethylhexanoate, zinc ethylhexanoate, zirconium ethylhexanoate, cerium ethylhexanoate and the tin dibutyl laurate.
in the case of the crosslinking of organopolysiloxanes by hydrosylilation, the addition of a catalyst may be necessary; this can be, for example, platinum or a suitable platinum-based catalyst such as the Karstedt catalyst or Ashbys catalyst.

A crosslinking agent bearing, for example, Si—H bonds may be present.

According to an embodiment, the proportion of silicone resin in the layer (3a) is greater than or equal to 20% by weight relative to the total weight respectively of the layer (3a).

According to another embodiment, the proportion of silicone resin in the layer (3a) is greater than or equal to 40% by weight relative to the total weight respectively of the layer (3a).

According to yet another embodiment, the proportion of silicone resin in the layer (3a) is greater than or equal to 50% by weight relative to the total weight respectively of the layer (3a).

According to an embodiment, the proportion of silicone resin in the layer (3b) is greater than or equal to 20% by weight relative to the total weight respectively of the layer (3b).

According to another embodiment, the proportion of silicone resin in the layer (3b) is greater than or equal to 40% by weight relative to the total weight respectively of the layer (3b).

According to yet another embodiment, the proportion of silicone resin in the layer (3b) is greater than or equal to 50% by weight relative to the total weight respectively of the layer (3b).

According to an embodiment, the proportion of silicone resin in the layer (3c) is greater than or equal to 20% by weight relative to the total weight respectively of the layer (3c).

According to another embodiment, the proportion of silicone resin in the layer (3c) is greater than or equal to 40% by weight relative to the total weight respectively of the layer (3c).

According to yet another embodiment, the proportion of silicone resin in the layer (3c) is greater than or equal to 50% by weight relative to the total weight respectively of the layer (3c).

### Thermoplastic Polymers

Advantageously, the one or more thermoplastic polymers are selected from the group consisting of polyaryletherketone(s) (PAEK), aromatic thermoplastic polymers such as poly(arylethersulfones) (PAES), poly(arylene sulfides) (PAS) or poly(phenylene oxide) (PPO), liquid crystal polymers, heterocyclic thermoplastic polymers and the mixtures thereof.

### PAEK

Advantageously, the one or more polyaryletherketones (PAEK) are selected from the group consisting of: polyetherketones (PEK), polyetheretherketone (PEEK), polyetherketoneketones (PEKK), polyetheretherketoneketones (PEEKK) and polyetherketoneetherketoneketones (PEKEKK), particularly preferably are PEEK.

### Other Aromatic Thermoplastic Polymers

Aromatic thermoplastic polymers include by way of example, according to the invention, poly(phenylene oxide) (PPO), poly(arylethersulfones) (PAES) polymers and, in particular, polyethersulfone (PES), polyphenylene ether sulfone (PPSU), the poly(arylene sulfides) (PAS) and in particular polyphenylene sulfide (PPS), liquid crystal polymers and the mixtures thereof.

### Heterocyclic Thermoplastic Polymers

Heterocyclic thermoplastic polymers include by way of example, according to the invention, polyetherimides (PEI), polyimides (PI), polyamideimides (PAI) and polybenzymidazole (PBI), or the mixtures thereof.

Advantageously, the one or more thermoplastic polymers are selected from the group consisting of polyethersulfone (PES), polyphenylene ether sulfone (PPSU), polyamideimide (PAI), polyimide (PI), poly(phenylene oxide) (PPO), poly(arylene sulfide) (PAS), polyetherimide (PEI), polybenzymidazole (PBI), liquid crystal polymers (LCP), polyphenylene sulfide (PPS), polyarylether ketone (PAEK) including polyether ketone (PEK), polyether ether ketone (PEEK), polyether ketone ketone (PEKK), polyether ether ketone ketone (PEEKK), polyether ketone ether ketone ketone (PEKEKK) and the mixtures thereof.

According to an alternative, PAEK is used in the form of a suspension and the particles of PAEK in the PAEK suspensions have a particle size distribution with a d50 of approximately 10 μm to 15 μm.

Advantageously, the nature of the one or more thermoplastic polymers in the layers (3a), (3b) and (3c) can be identical or different.

Advantageously, the layer (3a) comprises one or more thermoplastic polymers, preferably in a proportion by weight of said layer less than 50%, preferably less than 40%.

Advantageously, the layer (3b) comprises one or more thermoplastic polymers, preferably in a proportion by weight of said layer less than 30%, preferably less than 20%.

Advantageously, the layer (3c) comprises one or more thermoplastic polymers, preferably in a proportion by weight of said layer less than 50%, preferably less than 40%.

According to an embodiment, the layer (3a) and the layer (3c) comprise one or more thermoplastic polymers, the proportion of thermoplastic polymers in the layer (3c) being preferably greater than the proportion of thermoplastic polymers in the layer (3a).

According to another embodiment, the layer (3a) and the layer (3c) comprise one or more thermoplastic polymers, the proportion of thermoplastic polymers in the layer (3a) being greater than the proportion of thermoplastic polymers in the layer (3c).

### Fillers

The fillers according to the invention provide mechanical reinforcement and can also provide hydrophobicity properties, while improving the mechanical strength and the thermal conductivity of the coating.

The fillers are not only there to provide colour to the coating, but can also contribute to it.

The presence of fillers with excellent thermal conductivity can compensate for the low thermal conductivity of PAEK polymers.

Advantageously, the one or more fillers are selected from the group consisting of ceramic (SiO₂, etc.) and/or mineral and/or metal (Al₂O₃, TiO₂, etc.) and/or silica and/or diamond particle fillers.

Preferably, the one or more fillers are selected from the group consisting of metal oxides, metal carbides, metal oxynitrides, metal nitrides and the mixtures thereof.

Advantageously, said metal is a transition metal, such as at least one of the elements selected from B, Ni, Ti, Zr or Hf.

Yet more preferably, the one or more fillers are selected from the group consisting of:
fillers for reinforcement: hard organic or inorganic fillers; the hard inorganic fillers are preferably particles of silicon carbide or alumina or zirconia, or graphite, or ceramics, or carbonate, or hydrated alumina, aluminium hydroxide or one or more metal oxides, graphite, graphene;
other fillers for the reinforcement selected from metal oxides: silica, micas, laminar fillers, clays such as montmorillonite, sepiolite, gypsite, kaolinite and laponite, zinc dioxide, quartz and zirconium phosphate, alumina, zirconia, zinc oxide, copper oxide and iron oxide;
fillers selected from the reinforcement fibres: glass, carbon or aramid fibre;
conductive fillers comprising a transition metal carbide and/or a transition metal nitride: characterised in that the transition metal is at least one of the elements selected from B, Ni, Ti, Zr or Hf,
   for example: cubic boron nitride, diamond particles, metal particles;
lamellar fillers, such as clays, graphene or graphite, can provide lubricating properties.

The preferred fillers in combination with organopolysiloxanes are:
reinforcing fillers: silica or carbonates with filler contents of at least 10-15 wt. % and up to 60 wt. %,
alumina, hydrated alumina, aluminium hydroxide,
silica (precipitated or pyrogenic) with a d50<0.1 μm and a specific surface area BET>30 m²/g and preferably between 30 and 500 m²/g,
or mixture of quartz and silica, diatomaceous earth or ground quartz, titanium, mica, talc, kaolin, barium sulfate, slaked lime, zinc oxide, expanded vermiculite, unexpanded vermiculite, calcium carbonate etc.

Yet more preferably, the one or more fillers are selected from the group consisting of alumina, silicon carbide, tungsten carbide, boron nitride, quartz, and the mixtures thereof.

Advantageously, the median diameter d50 of the fillers is between 0.1 and 50 μm, more advantageously between 5 and 15 μm.

Advantageously, the proportion of fillers in a layer is between 0.5 and 30% by dry weight relative to the total weight of said layer after curing, preferably between 5 and 20%.

Advantageously, the proportion of fillers in the layer (3a) is less than 10% by weight relative to the total weight of said layer.

Advantageously, the proportion of fillers in the layer (3b) is less than 10% by weight relative to the total weight of said layer.

Advantageously, the proportion of fillers in the layer (3c) is less than 10% by weight relative to the total weight of said layer.

Advantageously, the proportion of fillers in the layers (3a), (3b) and (3c) is less than 10% by weight relative to the total weight respectively of layer (3a)/layer (3b)/layer (3c).

Advantageously, the proportion of fillers in the layers (3a), (3b) and (3c) can be identical or different.

Advantageously, the nature of the fillers in layers (3a), (3b) and (3c) can be identical or different.

### Additives

Advantageously, said additives are selected from the group consisting of anti-foaming agents, dispersants, wetting agents, thickeners, pH regulators, reactive silicone oils.

Said one or more anti-foaming agents are preferably selected from the group consisting of mineral oils, diols, hydrocarbons, glycerides, oxyrane and emulsified fatty acids.

The one or more surfactants are preferably selected from the group consisting of glycol ether, ethoxylated alcohol with the exclusion of alkyl phenol ethoxylates (APE), gemini surfactants.

The one or more dispersants are preferably selected from the group consisting of anionic dispersants such as fatty acid derivatives.

Said thickeners are preferably selected from the group consisting of acrylic-based or polyurethane-based copolymer, cellulose and pyrogenic silica.

Said pH regulators are preferably selected from the group consisting of Bronsted bases: ammonia, amines (triethyl amine, triethanolamine . . . ), (sodium, potassium, etc.) hydroxides, carbonates.

Advantageously, the proportion of additives in the layer (3a) is less than 20% by weight relative to the total weight of said layer.

Advantageously, the proportion of additives in the layer (3b) is less than 20% by weight relative to the total weight of said layer.

Advantageously, the proportion of additives in the layer (3c) is less than 20% by weight relative to the total weight of said layer.

Advantageously, the proportion of additives in the layers (3a), (3b) or (3c) is less than 20% by weight relative to the total weight of the layer (3a)/layer (3b)/layer (3c).

### Colouring Agents

Advantageously, the one or more colouring agents are selected from the group consisting of thermochromic pigments, thermostable pigments, flakes and the mixtures thereof.

Advantageously, the proportion of colouring agents in a layer is between 0.5 and 50% by dry weight relative to the total weight of said layer after curing.

Advantageously, the proportion of colouring agents in the layer (3a), when present, ranges from 10% to 40% by weight relative to the total weight of said layer.

Advantageously, the proportion of colouring agents in the layer (3b) ranges from 10% to 40% by weight relative to the total weight of said layer.

Advantageously, the proportion of colouring agents in the layer (3c), when present, is less than 10% by weight relative to the total weight of said layer.

Advantageously, the proportion of colouring agents in the layers (3a), (3b) and (3c) can be identical or different.

Advantageously, the nature of the colouring agents in the layers (3a), (3b) and (3c) can be identical or different.

### Thermochromic Pigments

Preferably, the one or more thermochromic pigments are selected from the group consisting of Bi₂O₃, Fe₂O₃, V₂O₅, WO₃, CeO₂, In₂O₃, Y_{1.84}Ca_{0.16} Ti_{1.84}V_{0.16}O_{1.84}, AgI, (Bi₁₋ₓAₓ) (V_{1-y}M_{y})O₄ with:
x is equal to 0 or x is between 0.001 and 0.999,
Y is equal to 0 or y is between 0.001 and 0.999,
A and M are chosen from the group consisting of nitrogen, phosphorus, an alkali metal, an alkaline earth metal, a transition metal, a poor metal, a metalloid or a lanthanide,

A and M are different from each other.

Knowing that A and M are different from each other, when:
A is an alkali metal, it can be selected from Li, Na, K, Rb, Cs,
M is an alkali metal, it can be selected from Li, Na, K, Rb, Cs,
A is an alkaline earth metal, it can be selected from Be, Mg, Ca, Sr, Ba,
M is an alkaline earth metal, it can be selected from Be, Mg, Ca, Sr, Ba,
A is a transition metal, it can be selected from Sc, Ti Cr, Mn, Fe, Co, Ni, Cu, Y, Zr, Nb, Mo, Ru, Rh, Pd, Ag, Ta, W, Ir,
M is a transition metal, it can be selected from Sc, Ti Cr, Mn, Fe, Co, Ni, Cu, Y, Zr, Nb, Mo, Ru, Rh, Pd, Ag, Ta, W, Ir,
A is a poor metal, it can be selected from Al, Zn, Ga, In, Sn,
M is a poor metal, it can be selected from Al, Zn, Ga, In, Sn,
A is a metalloid, it can be selected from B, Si, Ge, Sb,
M is a metalloid, it can be selected from B, Si, Ge, Sb,
A is a lanthanide, it can be selected from La, Ce, Pr, Nd, Pm, Sm, Eu, Gd, Tb, Dy, Ho, Er, Tm, Yb, Lu,
M is a lanthanide, it can be selected from La, Ce, Pr, Nd, Pm, Sm, Eu, Gd, Tb, Dy, Ho, Er, Tm, Yb, Lu.

Preferably, A and M, different from each other, are B and/or Mg.

Preferably, the pigment (Bi₁₋ₓAₓ) (V_{1-y}M_{y})O₄ has a monoclinic scheelite crystalline form at ambient temperature.

Preferably, x and y are 0, i.e. the pigment (Bi₁₋ₓAₓ) (V_{1-y}M_{y})O₄ is bismuth vanadate (BiVO₄). Advantageously, BiVO₄ is used, which has a monoclinic scheelite structure at ambient temperature.

Bismuth vanadate is a yellow-coloured inorganic compound, of formula BiVO₄, widely used for its colouring properties and for its lack of toxicity. It is entered in the Colour Index International as Q. I. Pigment Yellow 184, is marketed, in particular, by Heubach (Vanadur®), BASF (Sicopal®), FERRO (Lysopac) and by Bruchsaler Farbenfabrik (Brufasol®).

### Thermostable Pigments

Preferably, the one or more thermostable pigments are selected from the group consisting of:
titanium rutile yellow pigment,
yellow pigment derived from bismuth, for example selected from the stabilised bismuth vanadates (Py₁₈₄)
red pigment, for example selected from perylene red (for example PR149, PR178 and PR224), iron oxide,
bismuth oxyhalide orange pigment (PO₈₅),
bismuth vanadate orange pigment (PO₈₆)
tin titanium zinc orange pigment (PO₈₂)
cerium sulfide orange pigment (PO₇₅; PO₇₈)
chromium antimony titanium rutile orange-yellow pigment (PBr₂₄)
zinc tin rutile orange-yellow pigment (Py₂₁₆)
zinc tin sulfide niobium oxide orange-yellow pigment (Py₂₂₇)
niobium tin double oxide orange-yellow pigment
Co₃(PO₄)₂
LiCoPO₄
CoAl₂O₄
Cr₂O₃
TiO₂
black pigment PBk28 (Copper chromite black spinel)
and the mixtures thereof.

### Flakes

The flakes which can be used in the context of the present invention can be independently selected from coated or uncoated mica flakes, coated or uncoated silica flakes, coated or uncoated aluminium flakes and coated or uncoated iron oxide flakes. Mica or silica flakes coated with titanium dioxide. The flakes that can be used in the context of the present invention can be treated in order to give a particular colour effect.

Advantageously, the one or more flakes are particles chosen from the group consisting of particles of mica, aluminium, mica coated with titanium dioxide, or the mixtures thereof.

### Holographic Flakes

Advantageously, the one or more flakes are holographic flakes, i.e. a mixture of magnetisable particles and non-magnetisable particles.

The magnetisable particles can advantageously be particles comprising at least one ferromagnetic metal. These magnetisable particles can be homogeneous, i.e. formed of the same material, or composite, i.e. these magnetisable particles have a core-shell structure, in which the ferromagnetic metal is located in the core and/or in the shell of said particles. Examples of composite magnetisable particles include, in particular, mica flakes coated with iron oxide Fe₂O₃ or stainless-steel fibres coated with a sol-gel material, as protection against corrosion during the steps of implementing the coating, or else flakes made of plastic material and coated with iron oxide Fe₂O₃, or flakes for which the core is made of ferromagnetic metal and the shell is formed of a plastic material or of a sol-gel material. According to an embodiment, some of said magnetisable particles are oriented so as to form a three-dimensional decoration.

Advantageously, the mixture of magnetisable particles and non-magnetisable particles represents between 1% and 5% by weight of the weight of the layer, preferably between 2% and 3% by weight.

Advantageously, the percentage of non-magnetisable particles in the mixture of magnetisable particles and non-magnetisable particles is between 15% and 40% by weight relative to the total weight of the mixture of magnetisable particles and non-magnetisable particles.

Advantageously, the magnetisable particles have a size D50 less than equal to 23 μm.

In the context of the present invention, the term “D50” shall mean the maximum size exhibited by 50% of the particles by number.

Advantageously, the non-magnetisable particles have a size D90 between 20% and 250% of the size D90 of the magnetisable particles.

In the context of the present invention, the term “D90” shall mean the maximum size exhibited by 90% of the particles by number.

Advantageously, the magnetisable particles and/or the non-magnetisable particles are coloured at the surface.

Advantageously, the non-magnetisable particles are forms of mica, aluminium or mica coated with titanium dioxide.

Advantageously, the magnetisable particles are formed of iron, iron oxide, aluminium coated with iron, or mica coated with iron, the iron being in ferritic form.

### Decorations

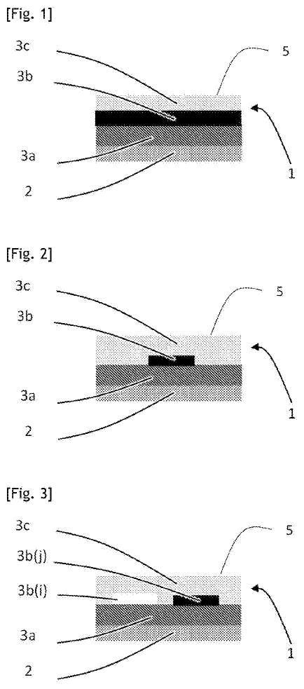

According to an embodiment, the one or more layers (3b) are continuous and cover the entirety of the layer (3a) (see FIG. 1).

According to another embodiment, the one or more layers (3b) do not cover the entirety of the layer (3a) and form at least one decoration (see FIG. 2).

Advantageously, the one or more layers (3b) form a plurality of decorations, one (i) comprising one or more thermochromic pigments and the other (j) comprising at least one reference temperature pigmentary composition (see FIG. 3).

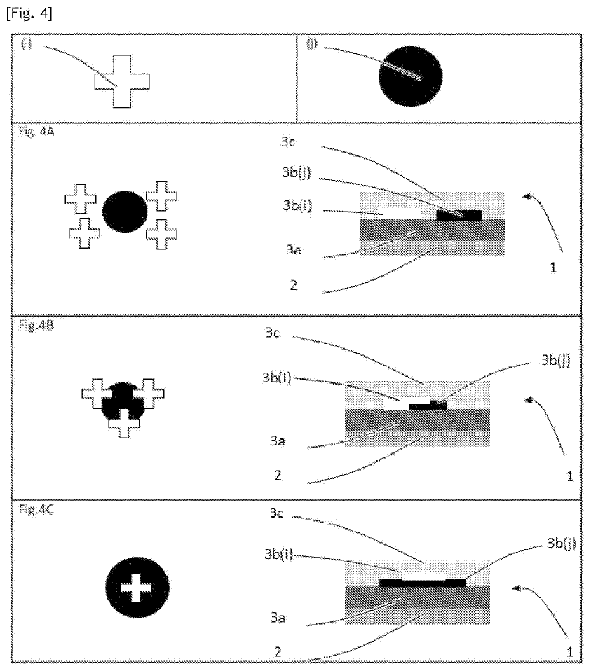

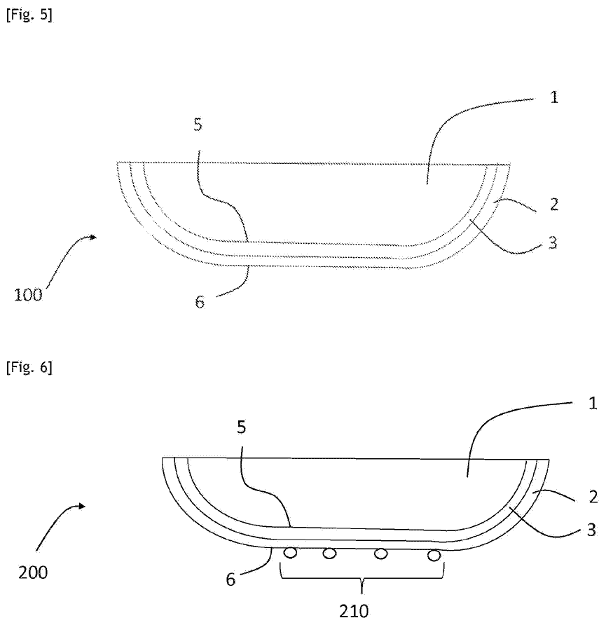

According to an embodiment, each of the two decorations (i) and (j) is in the form of non-overlapping adjacent patterns. For example, each decoration is represented by different geometric patterns uniformly distributed over the entire surface and alternating with respect to one another (see FIG. 4A).

According to another embodiment, the two decorations (i) and (j) are partially overlapping. For example, each decoration is represented by different geometric patterns uniformly distributed over the entire surface and partially overlapping (see FIG. 4B).

Preferably, the two decorations (i) and (j) are overlapping, either because one of the two decorations is a continuous layer and the other decoration covers it in the form of patterns, or because the two decorations (i) and (j) are in the form of overlapping patterns (see FIG. 4C).

### Method

The invention also relates to a method for manufacturing a coated cooking element (1) according to any one of the preceding claims, comprising the following successive steps:
i. supplying a metal substrate (2) having a face (2a),
ii. optionally, prior treatment of the face (2a) of said metal substrate (2) intended to be coated,
iii. applying the base layer (3a),
iv. drying the base layer (3a),
v. applying one or more intermediate layers (3b),
vi. optionally, drying the one or more intermediate layers (3b),
vii. applying the finishing layer (3c).

Advantageously, the steps of the method according to the invention make it possible to coat the metal substrate (2) with a coating (3) formed by the 3 layers (3a), (3b) and (3c). In general, these 3 layers are wet at the time of their application. In the context of the present invention, “wet layer” shall mean that the layer comprises all or part of its solvents.

Preferably, all or part of the solvents of the wet layer are removed, either naturally or by a physical treatment, for example thermal drying, drying by an air flow or by vacuum treatment.

Advantageously, the coating composition according to the invention can further comprise at least one solvent. Advantageously, the solvent can be a protic solvent. Advantageously, the solvent can be non-toxic

The solvent that can be used in the coating composition according to the invention, can advantageously comprise at least one alcohol, and can preferably be selected from isopropanol, methanol, ethanol and the mixtures thereof.

The application of the coating is made in several layers. In this case, the deposition on at least one of the two opposite faces of said substrate, of at least one layer of the coating (3) according to the invention, is repeated several times. Preferably, a drying step is carried out between the application of each layer, then the curing of said coated substrate is carried out after application of the last layer. The application of the coating (3) by the method according to the invention on the substrate (2) makes it possible to obtain a layer of thermostable coating.

The coating formula to be coated is generally in aqueous form, the polymers of the polymer phase being in the form of suspensions. Other non-aqueous solvents may also be suitable.

Advantageously, the method for manufacturing a coated cooking element (1) according to the invention comprises one or more drying steps between 8° and 150 °C after application of each of the layers. The drying can be carried out by convection or infra-red.

The application of the coating according to the invention by the method according to the invention can be made on the flat substrate or on the shaped substrate, or even on a locally flat zone of the shaped substrate. A layer of thermostable coating is obtained. In general, this coating layer is wet.

Advantageously, the method for manufacturing a coated cooking element (1) according to the invention comprises a step of shaping said support (2) before step iii, or after step vii. or after step viii. of curing. The shaping is also called stamping.

When the shaping step precedes the application iii of the coating, the coating is preferably carried out by spraying.

When this shaping step is subsequent to the application vii. of the coating, the coating is preferably carried out by screen printing or by roller.

The method according to the invention advantageously comprises a step viii. of curing the element obtained in step vii. of the method. In the context of the present invention, “curing the coated substrate, shall mean a thermal treatment which enables the one or more coating layers applied on the substrate to be densified, but also to crosslink the organopolysiloxane (silicone resin) precursors.

The method also relates to a method for manufacturing a coated cooking element (1) according to any one of the preceding claims, comprising the following successive steps:
i. supplying a metal substrate (2) having a face (2a),
ii. Optionally, prior treatment of the face (2a) of said metal substrate (2) intended to be coated,
iii. applying the base layer (3a),
iv. drying the base layer (3a),
v. applying one or more intermediate layers (3b),
vi. optionally, drying the one or more intermediate layers (3b),
vii. applying the finishing layer (3c)
viii curing the element obtained in step vii.

The curing is carried out in step viii. In general, the curing temperature of step viii. is between 230 °C and 420 °C.

Advantageously, the method for manufacturing a coated cooking element (1) according to the invention comprises a single final curing step viii. of all the applied layers. This single curing step is carried out simultaneously for all the applied layers. This embodiment makes it possible to film, fuse and crosslink all of the layers together, so that they form just one coating.

Application steps (iii) and (vii) can be carried out by electrostatic powder coating, solvent-phase or aqueous-phase spraying, screen printing, roller or digital printing.

Application step (v) can be carried out by pad printing, screen printing, inkjet printing or flexography.

In the context of the present invention, “curing the coated substrate” shall mean a thermal treatment which enables the one or more coating layers applied on the substrate to be densified, but also to crosslink the organopolysiloxane (silicone resin) precursors.

Advantageously, the method for manufacturing a coated cooking element (1) according to the invention comprises a step of shaping said support (2) before or after step iii. The shaping is also called stamping.

### Preferred Architectures

According to an embodiment, the invention relates to a coated cooking element (1) for a culinary item or electrical cooking appliance, comprising a metal substrate (2) coated on at least one face (2a) exclusively by the following three layers, superposed in this order starting from the metal substrate (2):
(3a) a base layer consisting of one or more silicone resins and optionally
   one or more thermoplastic polymers, and/or
   one or more colouring agents selected from the group consisting of thermochromic pigments, thermostable pigments, flakes, and the mixtures thereof, and/or
   one or more fillers, and/or
   one or more additives
(3b) one or more intermediate layers consisting of one or more colouring agents selected from the group consisting of thermochromic pigments, thermostable pigments, flakes, and the mixtures thereof and optionally
   one or more silicone resins, and/or
   one or more thermoplastic polymers, and/or
   one or more fillers, and/or
   one or more additives
(3c) a finishing layer consisting of one or more silicone resins and optionally
   one or more thermoplastic polymers, and/or
   one or more fillers, and/or
   one or more additives.

According to an embodiment, the base layer (3a) consists of one or more silicone resins and optionally one or more thermoplastic polymers.

According to another embodiment, the base layer (3a) consists of one or more silicone resins and optionally
one or more colouring agents selected from the group consisting of thermochromic pigments, thermostable pigments, flakes, and the mixtures thereof, and/or
one or more fillers, and/or
one or more additives

According to an embodiment, the base layer (3a) consists of one or more silicone resins and one or more thermoplastic polymers.

According to an embodiment, the base layer (3a) and the finishing layer (3c) consist of one or more silicone resins and optionally one or more thermoplastic polymers.

According to an embodiment, the base layer (3a) and the finishing layer (3c) consist of one or more silicone resins and one or more thermoplastic polymers.

In these embodiments, the one or more thermoplastic polymers are advantageously selected from polyamideimide (PAI), polyimide (PI), polyetherimide (PEI), polybenzymidazole (PBI), polyethersulfone (PES), polyphenylene ether sulfone (PPSU), polyarylether ketone (PAEK), and the mixtures thereof.

Preferably, the colouring agent of the one or more intermediate layers (3b) comprises pigments and/or flakes, advantageously holographic flakes.

According to an alternative, the one or more intermediate layers (3b) consist of:
one or more colouring agents, in particular pigments and/or flakes, advantageously holographic flakes,
one or more thermoplastic polymers advantageously selected from polyamideimide (PAI), polyimide (PI), polyetherimide (PEI), polybenzymidazole (PBI), polyethersulfone (PES), polyphenylene ether sulfone (PPSU), polyarylether ketone (PAEK), and the mixtures thereof,
0 to 10% fillers,
0 to 20% additives,
optionally one or more silicone resins.

According to another alternative, the one or more intermediate layers (3b) consist of:
one or more colouring agents, in particular pigments and/or flakes, advantageously holographic flakes,
0 to 10% fillers,
0 to 20% additives,
one or more silicone resins, and
optionally, one or more thermoplastic polymers advantageously selected from polyamideimide (PAI), polyimide (PI), polyetherimide (PEI), polybenzymidazole (PBI), polyethersulfone (PES), polyphenylene ether sulfone (PPSU), polyarylether ketone (PAEK), and the mixtures thereof,
According to a particular alternative, the one or more intermediate layers (3b) do not comprise silicone resin.

According to another particular alternative, the one or more intermediate layers (3b) consist of:
one or more colouring agents, in particular pigments and/or flakes, advantageously holographic flakes,
one or more thermoplastic polymers advantageously selected from polyamideimide (PAI), polyimide (PI), polyetherimide (PEI), polybenzymidazole (PBI), polyethersulfone (PES), polyphenylene ether sulfone (PPSU), polyarylether ketone (PAEK), and the mixtures thereof,
0 to 10% fillers,
0 to 20% additives,
one or more silicone resins.

According to a particular embodiment, the coating comprises two intermediate layers (3b), of which at least one is a decoration layer. Advantageously, the one or more layers (3b) form a plurality of decorations, one (i) comprising one or more thermochromic pigments and the other (j) comprising at least one reference temperature pigmentary composition.

Typically, the thickness of the one or more assemblies of intermediate layers (3b) is between 3 μm and 10 μm.

Preferably, the one or more intermediate layers (3b) only cover part of the base layer (3a).

According to an embodiment, the finishing layer (3c) consists of one or more silicone resins and optionally one or more thermoplastic polymers, advantageously selected from polyamideimide (PAI), polyimide (PI), polyetherimide (PEI), polybenzymidazole (PBI), polyethersulfone (PES), polyphenylene ether sulfone (PPSU), polyarylether ketone (PAEK), and the mixtures thereof.

Typically, the thickness of the layer (3c) is between 0.1 μm and 10 μm.

In a particular embodiment, the thickness of the layer (3a) is between 30 μm and 70 μm, the thickness of the one or more layers (3b) is between 3 μm and 10 μm, and the thickness of the layer (3c) is between 0.1 μm and 10 μm.

### ITEM

The invention also relates to a culinary item (100) comprising a coated cooking element (1).

According to an embodiment, the culinary item (100) comprises a heating face (6) intended to be placed in contact with an external heating source, the heating face (6) being opposite the cooking face (5) intended to be placed in contact with the food during cooking.

Advantageously, the culinary item (100) according to the invention is chosen from the group consisting of a saucepan, frying pan, pans or pots for fondue or raclette, stew pot, wok, sauté pan, crêpe maker, grill, plancha grill, cooking pot, casserole, vessel for a cooker or bread-making machine, culinary mould.

The invention also relates to an electric cooking appliance (200) comprising a coated cooking element (1) according to the invention and a heating source (210) designed to heat said coated cooking element (1).

Advantageously, the electric cooking appliance (200) is chosen from the group consisting of an electric crêpe maker, electric raclette appliance, electric fondue appliance, electric grill, electric plancha grill, electric cooker, bread-making machine, electric pressure cooking appliances, waffle makers, rice cookers and jam makers.

The culinary item according to the present invention can, in particular, be a culinary item for which one of the two opposite faces of the substrate is an inner, optionally concave, face intended to be arranged on the side of food likely to be introduced into or onto said item, and for which the other face of the substrate is an, optionally convex, outer face intended to be arranged facing a heat source.

By way of non-limiting examples, culinary items according to the present invention include, in particular, culinary items such as pots and pans, woks and the sauté pans, stew pots and casseroles, crêpe makers, baking pans and trays, barbecue plates and grills, and preparation bowls.

### EXAMPLES

The goals, aspects and advantages of the present invention will be better understood on reading the following description of a particular embodiment of the invention presented by way of non-limiting example.

Of course, the invention is in no way limited to the embodiment described and Illustrated, which is only given by way of example. Modifications remain possible, in particular in terms of the constitution of the various elements or by substitution of technical equivalents, without going beyond the scope of protection of the invention.

### 1) Exemplary Embodiments

Metal substrate: this is an aluminium support which is sandblasted or shot peened and then passed into a surface treatment suitable for removing organic contaminants.

### Raw Materials:

### Silicone Resins:

RS1: ethoxy functionalised polyester silicone resin (80% silicone/20% polyester) in solvent phase, viscosity at 25 °C approx. 2000 mPas, solids content=75%
RS2: ethoxy functionalised polyester silicone resin (50% silicone/50% polyester) in solvent phase, viscosity at 25 °C approx. 2000 mPas, solids content=75%
RS3: ethoxy functionalised polyester silicone resin (30% silicone/70% polyester) in solvent phase, viscosity at 25 °C approx. 2000 mPas, solids content=75%
RS4: methyl phenyl functionalised polyester silicone resin in solvent phase, viscosity at 25 °C approx. 2000 mPas, solids content=75%
RS5: methoxy functionalised polyester silicone resin (50% silicone/50% polyester) in solvent phase, viscosity at 25 °C approx. 2000 mPas, solids content=75%
RS6: ethoxy functionalised methyl organopolysiloxane resin in aqueous emulsion, viscosity at 25 °C approx. 1500 mPas, solids content=52%

### Heterocyclic Polymer Resins:

polyamide-imide resin (PAI) at 29% dry extract in N-butylpyrrolidone (NBP), Torlon from SOLVAY

### Other Aromatic Polymer Resins:

powdered polyetheretherketone (PEEK), Vicote 703 from VICTREX, powdered polymer with a d50 of 25 μm,
powdered polyetheretherketone (PEEK), Vicote 704 from VICTREX, powdered polymer with a d50 of 10 μm,
powdered PEKK resin, KEPSTAN 7002 PT from Arkema with a d50 of 20 μm,
powdered PEKK resin, KEPSTAN 6002 PT from Arkema with a d50 of 50 μm,
powdered polyethersulfone (PES) resin, micronised grade from SOLVAY, polymer powder with a d50 of 40 μm.

### Alcohol Solvent

dipropylene glycol butyl ether (DPNB),
2-methoxy-1-methylethyl acetate (MPA),
butyl glycol acetate (BGA),
butyl acetate,

### Surfactant and Anti-Foaming Agent

mineral oil: Tego foamex K7 from Evonik
fatty alcohol polyglycol ether: Genapol X080 from Clariant or Tergitole TMN-100X,

### Reinforcing Fillers:

pyrogenic silica: Levasil CC301,
fumed silica after treated with dimethyl dichlorosilane: Aerosil R972

### Pigments:

mica: IRIODIN 100 or IRIODIN 300 and/or Magnapearl 5000,
Cr/Fe oxide: Sicopal black K0098FK,
carbon black: Derussol F25 or Cabot Monarch 4750,
perylene red: Paliogen red (PR178)
iron III oxide: H856 brick

### Acrylic Resin:

Rohagit SD 15: acrylic polymer solution with 30% in aqueous phase Silicone oil:
polyether modified polysiloxane: TEGO GLIDE 100,
polydimethylsiloxane oil: CT 601M

### Other Additives:

AMP 90: solution of 2-amino-2-methyl-1-propanol: polymer with 90% in aqueous phase, buffer agent,
Metolat 368: fatty acid ester,
Dolfynox 1030: propoxylated polyglycol ether, wetting agent,
Edaplan LA 451: anionic ester in ethanol/water, wetting agent
Tego Glide 407: methyl phenyl polysiloxane, flow agent.

### Operating Principle of the Jar Mill (Mechanical Grinder)

Ball milling involves loading a jar with the sample to be ground and the so-called grinding balls, and rotating the jar around its axis at a certain speed. The rotation of the jar is generally achieved using a roller machine. This sample can be ground in dry form or dispersed in an appropriate solvent (for example in water or in alcohol). The dispersion can also contain certain adjuvants (such as a dispersant or an anti-foaming agent).

The median diameter of the grinding balls must be adapted to the size of the particles to be ground. The finer the particles, the smaller the diameter of the balls to be used. The total volume of balls, including the spaces between the balls, will represent approximately 50-60% of the internal volume of the jar. Balls of different sizes are advantageously distributed according to the following weighted proportion relative to the total weight of the balls: 25% small balls, 50% medium balls and 25% large balls. The smallest dimension of the balls is between 2 and 10 mm. Stabilised alumina and zirconia are commonly used as the material of the balls.

### Exemplary Embodiment of a Culinary Item According to the Invention:

On a shaped aluminium disc (30 cm diameter), previously degreased and sandblasted in order to obtain a roughness of 4 to 7 μm (Ra), a continuous layer 3a is deposited, selected from the base-layer compositions as described below: base layer 3a1, base layer 3a2 and base layer 3a3:

| | | | % in solid phase, |
|---|---|---|---|
| Base layer component 3a1 | role | % liquid | after curing |
| Silicone resin: | binder | 30 | 59.6 |
| RS1 or RS2 or RS3 or | | | |
| RS4 or RS5 or RS6 | | | |
| dipropylene glycol butyl ether | solvent | 3 | 0 |
| Fatty acid ester | | 3 | 0.5 |
| Cr/Fe oxide | pigment | 10 | 33.1 |
| Deionised water | solvent | 41.40 | 0 |
| Fatty alcohol polyglycol ether | | 4.60 | 0.6 |
| Mineral oil | anti- | 2 | 0.7 |
| | foaming | | |
| | agent | | |
| Silica | | 5 | 5 |
| 2-amino-2-methyl-1-propanol | | 0.5 | 0 |
| Acrylic polymer | thickener | 0.5 | 0.5 |
| TOTAL | | 100 | 100 |

| | | | % in solid |
|---|---|---|---|
| | | % | phase, |
| Base layer component 3a2 | role | liquid | after curing |
| Silicone resin: | binder | 30 | 44.8 |
| RS1 or RS2 or RS3 or RS4 or | | | |
| RS5 or RS6 | | | |
| Thermoplastic polymers: | binder | 10 | 24.9 |
| PES or PAI or PEEK | | | |
| Dipropylene glycol butyl ether | solvent | 3 | 0 |
| Fatty acid ester | | 3 | 0.4 |
| Cr/Fe oxide | pigment | 10 | 24.9 |
| Deionised water | solvent | 31.40 | 0 |
| Fatty alcohol polyglycol ether | | 4.60 | 0.5 |
| Mineral oil | anti-foaming | 2 | 0.5 |
| | agent | | |
| Silica | | 5 | 3.7 |
| 2-amino-2-methyl-1-propanol | | 0.5 | 1.14 |
| Acrylic polymer | thickener | 0.5 | 0.4 |
| TOTAL | | 100 | 100 |

| | | | % in solid |
|---|---|---|---|
| | | % | phase, |
| Base layer component 3a3 | role | liquid | after curing |
| Silicone resin RS2 | binder | 62 | 78.81 |
| 2-methoxy-1-methylethyl acetate | solvent | 8 | 0 |
| Cr/Fe oxide | pigment | 10 | 21.19 |
| Butyl glycol acetate | solvent | 1 | 0 |
| Butyl acetate | solvent | 19 | 0 |
| TOTAL | | 100 | 100 |

The aqueous composition of the base layer 3a is prepared according to the ball milling principle. The ball milling is carried out in a jar as described above. The sample can be ground in dry form or dispersed in an appropriate solvent (for example in water or alcohol or in a solvent). The dispersion can also contain certain adjuvants (such as a dispersant or an anti-foaming agent).

The thickness of this base layer 3a of the example is between 10 μm and 20 μm, preferably between 12 μm and 15 μm.

The substrate, on which the continuous base layer 3a is applied, as described above, is coated with a multilayer non-stick coating composed of an intermediate layer 3b (6-8 μm) which is dried for 4 minutes at 100 °C and a finishing layer 3c (14-18 μm). The assembly being finally heated to 250 °C for 1 hour, i.e. the method comprises only one curing step, after the deposit of the various layers.

The compositions of the intermediate layers 3b deposited by spraying are as described below (layer 3b1, layer 3b2 and layer 3b3):

| | | | % in solid |
|---|---|---|---|
| Intermediate layer | | % | phase, after |
| component 3b1 | role | liquid | curing |
| Silicone resin: | binder | 30 | 73.5 |
| RS1 or RS2 or RS3 or RS4 or | | | |
| RS5 or RS6 | | | |
| Dipropylene glycol butyl ether | solvent | 3 | 0 |
| Fatty acid ester | wetting agent | 3 | 0.6 |
| Mica | flakes | 3 | 12.3 |
| Cr/Fe oxide | pigment | 1 | 4.1 |
| Deionised water | solvent | 46.40 | 0 |
| Fatty alcohol polyglycol ether | emulsifying | 4.60 | 0.8 |
| | agent | | |
| Mineral oil | anti-foaming | 2 | 0.8 |
| | agent | | |
| Silica | | 5 | 6.1 |
| 2-amino-2-methyl-1-propanol | | 0.5 | 0 |
| Acrylic polymer | thickener | 1.5 | 1.8 |
| TOTAL | | 100 | 100 |

| | | | % in solid |
|---|---|---|---|
| Intermediate layer | | % | phase, after |
| component 3b2 | role | liquid | curing |
| Silicone resin: | binder | 30 | 80 |
| RS1 or RS2 or RS3 or RS4 or | | | |
| RS5 or RS6 | | | |
| Dipropylene glycol butyl ether | solvent | 5 | 0 |
| Propoxylated polyglycol ether | wetting agent | 1 | 0.1 |
| Perylene red | pigment | 3 | 13.3 |
| Carbon black | pigment | 2 | 2.9 |
| Deionised water | solvent | 52 | 0 |
| Fatty acid polyglycol ether | emulsifying | 2 | 0.4 |
| | agent | | |
| Mineral oil | anti-foaming | 3 | 1.3 |
| | agent | | |
| 2-amino-2-methyl-1-propanol | buffer agent | 0.5 | 0 |
| Acrylic polymer | thickener | 1.5 | 2 |
| TOTAL | | 100 | 100 |

| | | | % in solid |
|---|---|---|---|
| Intermediate layer | | % | phase, after |
| component 3b3 | role | liquid | curing |
| Silicone resin: | binder | 30 | 75.4 |
| RS1 or RS2 or RS3 or RS4 or | | | |
| RS5 or RS6 | | | |
| Dipropylene glycol butyl ether | solvent | 5 | 0 |
| Propoxylated polyglycol ether | wetting agent | 1 | 0.1 |
| Iron (III) oxide | pigment | 5 | 21.0 |
| Deionised water | solvent | 52 | 0 |
| Fatty alcohol polyglycol ether | emulsifying | 2 | 0.3 |
| | agent | | |
| Mineral oil | anti-foaming | 3 | 1.3 |
| | agent | | |
| 2-amino-2-methyl-1-propanol | buffer agent | 0.5 | 0 |
| Acrylic polymer | thickener | 1.5 | 1.9 |
| TOTAL | | 100 | 100 |

The compositions of the finishing layers 3c deposited by spraying are as described below: layer 3c1 and layer 3c10:

| | | | % in solid |
|---|---|---|---|
| | | % | phase, after |
| Finishing layer component 3c1 | role | liquid | curing |
| Silicone resin RS1 | binder | 35 | 95.5 |
| Dipropylene glycol butyl ether | solvent | 6 | 0 |
| Propoxylated polyglycol ether | | 2 | 0.3 |
| Mineral oil | anti-foaming | 1 | 0.5 |
| | agent | | |
| Mica | pigment | 0.5 | 2.3 |
| Deionised water | solvent | 50.5 | 0 |
| Fatty alcohol polyglycol ether | emulsifying | 4 | 0.7 |
| | agent | | |
| 2-amino-2-methyl-1-propanol | buffer agent | 0.5 | 0 |
| Acrylic polymer | thickener | 0.5 | 0.7 |
| TOTAL | | 100 | 100 |

| | | | % in solid |
|---|---|---|---|
| | | % | phase, after |
| Finishing layer component 3c2 | role | liquid | curing |
| Silicone resin RS1 | binder | 35 | 91.5 |
| dipropylene glycol butyl ether | solvent | 6 | 0 |
| anionic ester in ethanol/water | Wetting agent | 1 | 0.1 |
| Mineral oil | Anti-foaming | 1 | 0.4 |
| | agent | | |
| Polyether modified | oil | 0.5 | 2.2 |
| polysiloxane | | | |
| Polydimethylsiloxane oil | oil | 1 | 4.4 |
| Deionised water | solvent | 50, 50 | 0 |
| Fatty acid polyglycol ether | Emulsifying | 4 | 0.7 |
| | agent | | |
| 2-amino-2-methyl-1-propanol | Buffer agent | 0.5 | 0 |
| Acrylic polymer | thickener | 0.5 | 0.7 |
| TOTAL | | 100 | 100 |

| | | % | % in solid phase, |
|---|---|---|---|
| Finishing layer component 3c3 | role | liquid | after curing |
| Silicone resin RS1 | binder | 67 | 100 |
| 2-methoxy-1-methylethyl acetate | solvent | 33 | 0 |

| | | % | % in solid phase, |
|---|---|---|---|
| Finishing layer component 3c4 | role | liquid | after curing |
| Silicone resin RS4 | binder | 69 | 100 |
| 2-methoxy-1-methylethyl acetate | solvent | 31 | 0 |

| | | % | % in solid phase, |
|---|---|---|---|
| Finishing layer component 3c5 | role | liquid | after curing |
| Silicone resin RS4 | binder | 80 | 100 |
| 2-methoxy-1-methylethyl acetate | solvent | 20 | 0 |

| | | | % in solid |
|---|---|---|---|
| | | % | phase, after |
| Finishing layer component 3c6 | role | liquid | curing |
| Silicone resin RS1 | binder | 75 | 87.38 |
| 2-methoxy-1-methylethyl acetate | solvent | 8 | 0 |
| Methyl phenyl polysiloxane | flow agent | 0.5 | 0.97 |
| Carbon black | pigment | 5 | 9.71 |
| Fumed silica after-treated with | filler | 1 | 1.94 |
| dimethyl dichlorosilane | | | |
| Butyl glycol acetate | solvent | 1 | 0 |
| Butyl acetate | solvent | 9.5 | 0 |
| TOTAL | | 100 | 100 |

| | | | % in solid |
|---|---|---|---|
| | | % | phase, after |
| Finishing layer component 3c7 | role | liquid | curing |
| Silicone resin RS1 | binder | 75 | 94.74 |
| 2-methoxy-1-methylethyl acetate | solvent | 8 | 0 |
| Fumed silica after-treated with | filler | 2 | 4.21 |
| dimethyl dichlorosilane | | | |
| Mica | pigment | 0.5 | 1.05 |
| Butyl glycol acetate | solvent | 1 | 0 |
| Butyl acetate | solvent | 13.5 | 0 |
| TOTAL | | 100 | 100 |

| | | | % in solid |
|---|---|---|---|
| | | % | phase, after |
| Finishing layer component 3c8 | role | liquid | curing |
| Silicone resin RS6 | binder | 30 | 74.26 |
| Fumed silica after-treated with | filler | 2 | 8.25 |
| dimethyl dichlorosilane | | | |
| Dipropylene glycol butyl ether | solvent | 4.5 | 0 |
| Fatty acid ester | | 3 | 5.94 |
| Mica | pigment | 0.5 | 2.06 |
| Deionised water | solvent | 51.6 | 0 |
| Fatty alcohol polyglycol ether | emulsifying agent | 5.5 | 4.99 |
| Mineral oil | anti-foaming agent | 1.9 | 4 |
| 2-amino-2-methyl-1-propanol | buffer agent | 0.5 | 0 |
| Acrylic polymer | thickener | 0.5 | 0.5 |
| TOTAL | | 100 | 100 |

| | | | % in solid |
|---|---|---|---|
| | | % | phase, after |
| Finishing layer component 3c9 | role | liquid | curing |
| Silicone resin RS2 | binder | 70 | 94.74 |
| 2-methoxy-1-methylethyl acetate | solvent | 8 | 0 |
| Fumed silica after-treated with | filler | 2 | 4.21 |
| dimethyl dichlorosilane | | | |
| Mica | pigment | 0.5 | 1.05 |
| Butyl glycol acetate | solvent | 1 | 0 |
| Butyl acetate | solvent | 13.5 | 0 |
| TOTAL | | 100 | 100 |

| | | | % in solid |
|---|---|---|---|
| | | % | phase, after |
| Finishing layer component 3c10 | role | liquid | curing |
| Silicone resin RS1 | binder | 60 | 92.78 |
| 2-methoxy-1-methylethyl acetate | solvent | 8 | 0 |
| Fumed silica after-treated with | filler | 2 | 4.21 |
| dimethyl dichlorosilane | | | |
| Mica | pigment | 0.5 | 1.05 |
| Butyl glycol acetate | solvent | 1 | 0 |
| Polydimethylsiloxane oil | oil | 1 | 2.06 |
| Butyl acetate | solvent | 19.7 | 0 |
| TOTAL | | 100 | 100 |

Method for Evaluating the Properties of the Non-Stick Coating: Performance Test with EGG

The method for evaluating the non-stick coating properties is carried out based on the egg test adapted from standard AFNOR NF D 21-511 paragraph 3.3.2, and implemented in the following manner:
The sample is cleaned, then the water remaining on the surface is wiped off.
The inner surface of the vessel body is dried beforehand.
The cooking vessel is heated on a gas hob to a temperature between 14° and 170 °C.
A size 60/65 egg is broken and then poured into the centre of the hot cooking vessel.

There is then a wait until the egg has coagulated (6 to 9 minutes). The egg is removed from the cooking vessel with the help of a spatula, the coating is cleaned using a damp vegetable sponge and, through this action, the non-stick properties of the cooking vessel are evaluated. A record is then made of:
Score 100: the egg is entirely removed using a plastic spatula;
Score 75: the egg is not entirely removed but the coating is easily cleaned with a damp sponge,
Score 50: the egg is not entirely removed but the coating can be cleaned with a damp sponge,
Score 25: the egg is not entirely removed and the coating is not cleaned with a damp sponge.
Score 0: the egg is not removed and the coating cannot be cleaned with a damp sponge.

| | Designs/architectures of cooking elements | | | | | | | | | |
|---|---|---|---|---|---|---|---|---|---|---|
| | according to the invention | | | | | | | | | |
| Base layer | 3a1 or 3a2 or 3a3 | | | | | | | | | |
| Intermediate layer | 3b1 or 3b2 or 3b3 | | | | | | | | | |
| Finishing layer | 3c1 | 3c2 | 3c3 | 3c4 | 3c5 | 3c6 | 3c7 | 3c8 | 3c9 | 3c10 |
| Scores obtained | 50 | 50 | 50 | 50 | 50 | 50 | 50 | 50 | 50 | 50 |
| in the egg test | | | | | | | | | | |

All of the silicone resin-polyester based coatings according to the invention exhibit good non-stick properties while being adherent to the metal.

1. A coated cooking element for a culinary item or electrical cooking appliance, comprising a metal substrate coated on at least one face by at least the following layers, in this order starting from the metal substrate:
a base layer consisting of one or more silicone resins,
or of one or more silicone resins and;
one or more thermoplastic polymers, and/or
one or more colouring agents selected from the group consisting of thermochromic pigments, thermostable pigments, flakes, and the mixtures thereof, and/or
one or more fillers, and/or
one or more additives
one or more intermediate layers consisting of one or more colouring agents selected from the group consisting of thermochromic pigments, thermostable pigments, flakes, and the mixtures thereof,
or of one or more colouring agents selected from the group consisting of thermochromic pigments, thermostable pigments, flakes, and the mixtures thereof and:
one or more silicone resins, and/or
one or more thermoplastic polymers, and/or
one or more fillers, and/or
one or more additives
a finishing layer consisting of one or more silicone resins or of one or more silicone resins and:
one or more thermoplastic polymers, and/or
one or more fillers, and/or
one or more additives, and/or
flakes.

2. The coated cooking element according to claim 1, wherein the one or more silicone resins are selected from the group consisting of methyl silicone and/or phenyl silicone and/or methyl-phenyl-silicone resins, methyl silicone-polyester resin (copolymers), phenyl silicone-polyester resin (copolymers), methyl-phenyl-silicones-polyester resin (copolymers), silicone-alkyd resin (copolymers), modified silicone resin.

3. The coated cooking element according to claim 1, wherein the one or more fillers, when present, are selected from the group consisting of ceramic and/or mineral and/or metal and/or silica and/or diamond particle fillers.

4. The coated cooking element according to claim 1, wherein the one or more thermoplastic polymers, when present, are selected from the group consisting of polyethersulfone (PES), polyphenylene ether sulfone (PPSU), polyamideimide (PAI), polyimide (PI), poly(phenylene oxide) (PPO), poly(arylene sulfide) (PAS), polyetherimide (PEI), polybenzymidazole (PBI), liquid crystal polymers (LCP), polyphenylene sulfide (PPS), polyaryletherketones (PAEK) including polyether ketone (PEK), polyether ether ketone (PEEK), polyether ketone ketone (PEKK), polyether ether ether ketone ketone (PEEKK) and polyether ketone ether ketone ketone (PEKEKK) and the mixtures thereof.

5. The coated cooking element according to claim 1, wherein the one or more thermochromic pigments are selected from the group consisting of Bi₂O₃, Fe₂O₃, V₂O₅, WO₃, CeO₂, In₂O₃, Y_{1.84}Ca_{0.16}Ti_{1.84}V_{0.16}O_{1.84}, AgI, (Bi₁₋ₓAₓ) (V_{1-y}M_{y})O₄ with
x is equal to 0 or x is between 0.001 and 0.999,
y is equal to 0 or y is between 0.001 and 0.999,
A and M are chosen from the group consisting of nitrogen, phosphorus, an alkali metal, an alkaline earth metal, a transition metal, a poor metal, a metalloid or a lanthanide,
A and M are different from each other.

6. The coated cooking element according to claim 1 wherein the one or more thermostable pigments are selected from the group consisting of:
titanium rutile yellow pigment,
yellow pigment derived from bismuth, for example selected from the stabilised bismuth vanadates (Py₁₈₄)
red pigment, for example selected from perylene red, iron oxide,
bismuth oxyhalide orange pigment (PO₈₅),
bismuth vanadate orange pigment (PO₈₆)
tin titanium zinc orange pigment (PO₈₂)
cerium sulfide orange pigment (PO₇₅; PO₇₈)
chromium antimony titanium rutile orange-yellow pigment (PBr₂₄)
zinc tin rutile orange-yellow pigment (Py₂₁₆)
zinc tin sulfide niobium oxide orange-yellow pigment (Py₂₂₇)
niobium tin double oxide orange-yellow pigment
CO₃(PO₄)₂
LiCoPO₄
CoAl₂O₄
Cr₂O₃
TiO₂
black pigment PBk28 (Copper chromite black spinel)
and the mixtures thereof.

7. The coated cooking element according to claim 1, wherein the one or more flakes, when present, are a mixture of magnetisable particles and non-magnetisable particles.

8. The coated cooking element according to claim 1, wherein said metal substrate is a substrate made of aluminium, stainless steel, cast iron or aluminium, iron, titanium or copper.

9. The coated cooking element according to claim 1, wherein:
the thickness of the base layer is between 10 μm and 100 μm, and
the thickness of the one or more intermediate layers is between 1 μm and 100 μm, and
the thickness of the finishing layer is between 0.05 μm and 100 μm.

10. The coated cooking element according to claim 1, wherein the proportion of silicone resin in the base layer or in the finishing layer is greater than or equal to 50% by weight relative to the total weight of the base layer or of the layer finishing respectively.

11. The coated cooking element according to claim 1, wherein the proportion of fillers, when present, in the base layers, the one or more intermediate layers or the finishing layer is less than 10% by weight relative to the total weight of the layer (3a), layer (3b) or layer (3c), respectively.

12. The coated cooking element according to claim 1, wherein the proportion of additives, when present, in the base layers, the one or more intermediate layers or the finishing layer is less than 20% by weight relative to the total weight of base layer/the one or more intermediate layers/the finishing layer.

13. The coated cooking element according to claim 1, wherein the base layer and the finishing layer comprise one or more thermoplastic polymers, the proportion of thermoplastic polymers in the finishing layer being greater than the proportion of thermoplastic polymers in the base layer.

14. A method for manufacturing a coated cooking element according to claim 1, comprising the following steps:
i. supplying a metal substrate having a face,
or supplying a metal substrate having the face and ii. treating the face of said metal substrate intended to be coated,
iii. applying the base layer,
iv. drying the base layer,
v. applying the one or more intermediate layers,
or applying the one or more intermediate layers and vi. drying the one or more intermediate layers,
vii. applying the finishing layer.

15. A culinary item comprising a coated cooking element according to claim 1.

16. The culinary item according to claim 15, comprising a heating face intended to be placed in contact with an external heating source, the heating face being opposite the cooking face intended to be placed in contact with foods during cooking.

17. The culinary item according to claim 15, chosen from the group consisting of a saucepan, frying pan, pans or pots for fondue or raclette, stew pot, wok, sauté pan, crêpe maker, grill, plancha grill, cooking pot, casserole, vessel for a cooker or bread-making machine and culinary mould.

18. An electric cooking appliance comprising a coated cooking element and a heat source configured to heat said coated cooking element, wherein said coated cooking element is according to claim 1.

19. The electric cooking appliance according to claim 18, chosen from the group consisting of an electric crêpe maker, electric raclette appliance, electric fondue appliance, electric grill, electric plancha grill, electric cooker, bread-making machine, electric pressure-cooking appliances, waffle makers, rice cookers and jam makers.
